(19) United States
(12) Patent Application Publication
(10) Pub. No.: US 2005/0272875 A1
(43) Pub. Date: Dec. 8, 2005

(54) Anionically polymerized impact polystyrene having good flowability

(75) Inventors: Philippe Desbois, Maikammer (DE); Hans-Dieter Schwaben, Freisbach (DE); Ulrike Dardin, Laudenbach (DE); Hans-Michael Walter, Freinsheim (DE)

Correspondence Address: CONNOLLY BOVE LODGE & HUTZ LLP, SUITE 800, 1990 M STREET NW, WASHINGTON, DC, 20036-3425, US

(73) Assignee: BASF Aktiengesellschaft, Ludwigshafen (DE)

(21) Appl. No.: 10/527,039

(22) PCT Filed: Sep. 4, 2003
(86) PCT No.: PCT/EP03/09808

§ 371 Date: Mar. 9, 2005

(30) Foreign Application Priority Data
Sep. 9, 2002 (DE) 102 41 850

(51) Int. Cl. C08L 25/02

(52) U.S. Cl. 525/241

(57) ABSTRACT

The invention relates to anionically polymerized impact polystyrene which is characterized in that it has a melt volume flow rate MVR of at least 8 cm³/10 min which is measured in accordance with EN ISO 1133 at a test temperature of 200°C. and with a nominal load of 5 kg.

The invention relates to an anionically polymerized, impact-modified polystyrene with good flowability, and also to thermoplastic molding compositions comprising this polystyrene. The invention further relates to a process for preparing the polystyrene mentioned, to an initiator composition for anionic polymerization, and to its use for preparing impact-modified polystyrene, and to the use of the impact-modified polystyrene or of the thermoplastic molding compositions for producing moldings, films, fibers, or foams, and finally to the moldings, films, fibers, and foams mentioned.

There are various known continuous and batch processes, in solution or suspension, for preparing impact-modified polystyrene, as described in Ullmann's Enzyklopädie, Vol. A21, VCH Verlagsgesellschaft Weinheim 1992, pp. 615-625. This process dissolves a rubber, usually polybutadiene, in monomeric styrene, and polymerizes the styrene by a free-radical route via thermal or peroxidic initiation, that is to say that the polymerization proceeds by way of free radicals. Examples of suitable peroxidic initiators are alkyl peroxides or acyl peroxides, hydroperoxides, peresters, or peroxicarbonates. Besides homopolymerization of styrene, graft polymerization of styrene on the polybutadiene also takes place. The formation of polystyrene and the simultaneous consumption of monomeric styrene causes “phase inversion”. The morphology, particle size, and particle size distribution of the disperse rubber particles determine the properties of the impact-modified polystyrene. They depend on various process parameters, such as the viscosity of the rubber solution and the shear forces during stirring.

Anionic polymerization for the preparation of impact-modified polystyrene differs fundamentally from the free-radical polymerization described above. The anionic polymerization generally uses organyl metal compounds as initiators, for example organyl lithium compounds, such as butyllithium. The polymerization proceeds by way of negatively-charged centers, for example by way of carbanions.

Since the reaction mechanisms in free-radical and anionic polymerization of styrene are different, the process parameters known from the free-radical preparation of impact-modified polystyrene are not directly transferable to the anionic polymerization of styrene in the presence of rubbers. For example, the reaction rate for the anionic polymerization is substantially higher than that for the free-radical polymerization, requiring different reaction temperatures, inter alia. Another example is that the rubber used cannot be exclusively homopolybutadiene, since no graft reactions occur during the anionic polymerization of styrene. The rubber phase used preferably comprises styrene-butadiene copolymers, e.g. styrene-butadiene block copolymers.

An example of a process for preparing thermoplastic molding compositions via anionic polymerization of styrene in the presence of styrene-butadiene block copolymers is disclosed in DE-A 42 35 978, WO 96/18666, WO 96/18682, WO 99/40135, or U.S. Pat. No. 4,153,647. The impact-modified products obtained have lower residual monomer contents and oligomer contents than the products obtained by free-radical polymerization.

WO 98/07766 describes the continuous preparation of impact-modified molding compositions using styrene-butadiene rubbers. The rubbers were polymerized anionically using additives with retardant action, for example alkyl compounds of alkaline earth metals, of zinc., and of aluminum, in styrene as solvent.

WO 99/67308 decribes anionically polymerized, impact-modified polystyrene with high stiffness and toughness.

WO 01/85816 discloses anionically polymerized, impact-modifed polystyrene with a specific rubber morphology.

The anionically polymerized impact-modified polystyrenes described above have a property profile which is not ideal for processing by injection molding. In particular, their flowability, measurable as melt volume flow ratio (MVR=melt volume ratio) is not ideal for injection molding, the MVR being smaller than 7 cm³/10 min at 200° C. High flowability is desirable when manufacturing components by injection molding, e.g. housings used as electronics housings and computer housings, and furniture components, and also household products, since it permits short cycle times and thus high productivity. In addition, the injection moldings should have good mechanical properties (toughness) and a visually satisfactory surface with high gloss.

Impact-modified polystyrene with better injection molding properties, i.e. better flowability (higher MVR) can be prepared by free-radical polymerization. For example, WO 00/32662 describes a free-radical-polymerized impact-modified polystyrene with a melt volume flow ratio of from 8 to 12 cm³/10 min and with a Charpy notched impact strength of from 16 to 20 kJ/m². However, this advantage is obtained at the cost of the abovementioned disadvantageous higher residual monomer contents and oligomer contents.

It is an object of the present invention to eliminate the disadvantages described. A particular object is to provide an impact-modified polystyrene which has low contents of residual monomers and oligomers together with good injection-molding properties. The intention was in particular to find an impact-modified polystyrene with high flowability. A process for its preparation was also to be found.

We have found that this object is achieved by means of an anionically polymerized, impact-modified polystyrene which has a melt volume flow ratio MVR of at least 8 cm³/10 min, measured to EN ISO 1133 at a test temperature of 200° C. with 5 kg nominal load.

The abovementioned thermoplastic molding compositions, processes, initiator compositions, and uses have also been found, as have the abovementioned moldings, films, fibers, and foams. Inventive embodiments with further detail can be found in the subclaims.

The standard EN ISO 1133 means the German standard DIN EN 1133:1999 (February 2002). The parameters test temperature 200° C. and nominal load 5 kg are also termed “test condition H” in that standard, see table A.1 on page 11 of the standard.

According to the invention, the melt volume flow ratio MVR of the impact-modified polystyrene is at least 8 cm³/10 min, measured to EN ISO 1133 at a test temperature of 200° C. with 5 kg load. It is preferably in the range from 8 to 20 cm³/10 min, in particular from 8 to 18 cm³/10 min.

In another, likewise preferred embodiment, the impact-modified polystyrene has high gloss. In particular, a specimen produced by injection molding with a melt temperature of 240° C. has a 20° reflectometer gloss value of at least 25%, measured to DIN 67530.

DIN 67530 means the German standard DIN 67530 (January 1982).

A test specimen produced at a melt temperature of 260° C. preferably has gloss of at least 30%, and a test specimen produced at a melt temperature of 280° C. preferably has gloss of at least 35% (the production of the test specimen and the measurement method being in other respects as described above).

In another, likewise preferred embodiment, the polystyrene of the invention has high impact strength. In particular, the specimen produced to EN ISO 3167 has a Charpy notched impact strength a_{K} of at least 8 kJ/m², measured to EN ISO 179/leA, with a milled notch at 23° C.

EN ISO 3167 means the German standard DN EN ISO 3167:1996 (March 1997). EN ISO 179/leA means the German standard DIN EN 179:1996 (March 1997), the suffix “leA” meaning: test specimen type 1, impact direction e (=edge), notch type A (=V-shaped notch). See table 2 on page 5, table 3 on page 6, and also the upper part of page 8, and FIG. 4 on page 9 of EN ISO 179.

In another preferred embodiment, the polystyrene of the invention has at least one of the following mechanical and thermal properties:
modulus of elasticity E of at least 1800 MPa, determined in the tensile test to EN ISO 527 (German standards DIN EN ISO 527-1:1996 (April 1996) and DIN EN ISO 527-2:1996 (July 1996)), at 23° C.
yield stress σₛ of at least 25 MPa, determined in the tensile test to EN ISO 527 (as above) at 23° C.
tensile stress at break σ_{R} of at least 18 MPa, determined in the tensile test to EN ISO 527 (as above) at 23° C.
penetration energy W_{ges}
   a) of at least 5 kJ/m² with test specimen produced at a melt temperature of 200° C.
   b) of at least 6 kJ/m² with a test specimen produced at a melt temperature of 230° C.
   c) of at least 12 kJ/m² with a test specimen produced at a melt temperature of 260° C., determined in the penetration test EN ISO 6603-2 (German standard DIN EN ISO 6603-2:1996 (February 1997)) 23° C.
heat distortion temperature of at least 87° C., determined as Vicat softening point VSP, method B50 (force 50 N, heating rate 50° C./h) to EN ISO 306 (German standard DIN EN ISO 306:1996 (January 1997)).

The impact-modified polystyrene of the invention is prepared by anionic polymerization, in particular by anionic polymerization of monomeric styrene in the presence of a rubber. A rubber means polymers with a glass transition temperature Tg of 0° C. or below (determined by differential scanning calorimetry, DSC). Suitable rubbers are those based on butadiene or on other rubber-forming monomers, examples being polybutadiene (less preferred) or butadiene-styrene copolymers (preferred). Use of styrene-butadiene block copolymers is particularly preferred.

In all cases the result is a hard polystyrene matrix in which there is a dispersed rubber phase.

In one preferred embodiment, the impact-modified polystyrene of the invention may be prepared by anionic polymerization of styrene in the presence of a styrene-butadiene block copolymer, using an organyl alkali metal compound as anionic polymerization initiator and an organyl aluminum compound, organyl magnesium compound, or organyl zinc compound as retarder.

Examples of the styrene-butadiene block copolymers may be linear two-block S-B copolymers or three-block S-B-S or B-S-B copolymers (S=styrene block, B=butadiene block), as obtained in a manner known per se by anionic polymerization. The block structure is substantially the result of initial anionic polymerization of styrene alone, producing a styrene block. Once the styrene monomers have been consumed, the monomer is changed by adding monomeric butadiene, which is then anionically polymerized to give a butadiene block (process being known as sequential polymerization). The resultant two-block S-B polymer may be polymerized to give a three-block S-B-S polymer via another change of monomer to styrene, if desired. The same principle applies to three-block B-S-B copolymers.

In particular when three-block S-B-S copolymers are used as rubber, the impact-modified anionic polystyrene of the invention has better mechanical properties than an impact-modified polystyrene prepared by a free-radical route.

In the case of the three-block copolymers, the two styrene blocks may be of equal size (equal molecular weight, i.e. symmetrical S₁₋-B-S₁ structure) or may differ in size (different molecular weight, i.e. asymmetric S₁₋B-S₂ structure). The same principle applies to the two butadiene blocks of the B-S-B block copolymers. Of course, S-S-B or S₋S₂₋B, or S-B-B, or S-B₁-B₂ block sequences are also possible. The indices above represent the block sizes (block lengths or molecular weights). The block sizes depend, for example, on the amounts of monomer used and the polymerization conditions.

There may also be B/S blocks in place of the “soft” elastomeric butadiene blocks B or in addition to the blocks B. The B/S blocks are likewise soft, and contain butadiene and styrene, for example with random distribution or in the form of a tapered structure (tapered=gradient from styrene-rich to styrene-poor or vice versa). If the block copolymer contains two or more B/S blocks, the absolute amounts, and the relative proportions, of styrene and butadiene in each of the B/S blocks may be identical or different, giving different blocks (B/S)₁, (B/S)₂, etc.

Four-block and polyblock copolymers are also suitable styrene-butadiene block copolymers.

The block copolymers mentioned may have a linear structure (described above). However, branched or star structures are possible and are preferred for some applications. Branched block copolymers are obtained in the known manner, e.g. by graft reactions of polymeric “branches” onto a main polymer chain.

An example of a method for obtaining star block copolymers is reaction of the living anionic chain ends with an at least bifunctional coupling agent. These coupling agents are described by way of example in U.S. Pat. Nos. 3,985,830, 3,280,084, 3,637,554, and 4,091,053. Preference is given to epoxidized glycerides (e.g. epoxidized linseed oil or soy oil), silicon halides, such as SiCl₄, or else divinylbenzene, or polyfunctional aldehydes, ketones, esters, anhydrides, or epoxides. Other suitable compounds specifically for dimerization are dichlorodialkylsilanes, dialdehydes, such as terephthalaldehyde, and esters, such as ethyl formate. Symmetrical or asymmetric star structures can be prepared by coupling identical or different polymer chains, meaning that each of the arms of the star may be identical or different and may in particular contain different blocks S, B, B/S, or different block sequences. Other details concerning star block copolymers are found by way of example in WO-A 00/58380.

The terms styrene and butadiene used above for monomers are examples and also represent other vinylaromatics and dienes, respectively.

The rubber for preparing the impact-modified polystyrene of the invention particularly preferably comprises an asymmetric styrene-butadiene-styrene three-block S₁-B-S₂ copolymer, where S₁ is a styrene block with a weight-average molar mass M_{w} in the range from 5000 to 100 000 g/mol, preferably from 10 000 to 40 000 g/mol, and B is a butadiene block with a weight-average molar mass M_{w} in the range from 12 000 to 500 000 g/mol, preferably from 70 000 to 250 000 g/mol, and S₂ is a styrene block with a weight-average molar mass M_{w} in the range from 30 000 to 300 000 g/mol, preferably from 50 000 to 200 000 g/mol.

The residual butadiene content of the styrene-butadiene block copolymers used and of the homopolybutadiene in the butadiene block should be below 200 ppm, preferably below 50 ppm, in particular below 5 ppm.

The rubber content, based on the impact-modified polystyrene of the invention, is advantageously from 5 to 35% by weight, preferably from 14 to 27% by weight, and in particular from 18 to 23% by weight.

As mentioned, the rubbers used preferably comprise butadiene-styrene copolymers. In this case—i.e. if the rubber also contains styrene and/or another comonomer alongside butadiene—the butadiene content of the impact-modified polystyrene of the invention is naturally lower than the rubber content.

The butadiene content (irrespective of the rubber used) is preferably from 2 to 25% by weight, in particular from 8 to 16% by weight, and particularly preferably from 11 to 13% by weight, based on the impact-modified polystyrene of the invention.

The conversion, based on styrene of the hard matrix, is generally above 90%, preferably above 99%. The process can in principle also give complete conversion.

Use may also be made of other vinylaromatic monomers, instead of styrene, for the polymerization of the hard matrix and/or of the styrene blocks in the block copolymers. Examples of other suitable monomers are styrene, α-methylstyrene, p-methylstyrene, ethylstyrene, tert-butylstyrene, vinyltoluene, 1,2-diphenylethylene, and 1,1-diphenylethylene, and mixtures. It is particularly preferable to use styrene.

The rubbers may also contain other dienes instead of butadiene, examples being 1,3-pentadiene, 2,3-dimethylbutadiene, isoprene, and mixtures of these.

The anionic polymerization initiators usually used comprise organyl alkali metal compounds, in particular mono-, bi-, or multifunctional alkali metal alkyl, alkali metal aryl, or alkali metal aralkyl compounds. Organolithium compounds are advantageously used, examples being ethyl-, propyl-, isopropyl-, n-butyl-, sec-butyl-, tert-butyl-, phenyl-, diphenylhexyl-, hexamethylenedi-, butadienyl-, isoprenyl-, and polystyryllithium, or the multifunctional compounds 1,4-dilithiobutane, 1,4-dilithio-2-butene, or 1,4-dilithiobenzene. It is preferable to use sec-butyllithium.

The amount needed of the organyl alkali metal compound depends on the desired molecular weight, on the nature and amount of the other organyl metal compounds used and also on the polymerization temperature. It is generally in the range from 0.002 to 5 mol percent, based on the total amount of monomers.

The polymerization may be carried out in the absence or presence of a solvent. The polymerization advantageously takes place in an aliphatic, isocyclic, or aromatic hydrocarbon or hydrocarbon mixture, for example benzene, toluene, ethylbenzene, xylene, cumene, hexane, heptane, octane, or cyclohexane. Preference is given to the use of solvents with a boiling point above 95° C. It is particularly preferable to use toluene.

Additives which reduce polymerization rates, termed retarders, may be added to control the reaction rate, as described in WO 98/07766. Examples of suitable retarders are organyl metal compounds of an element of the second or third main group, or of the second transition group, of the Periodic Table. For example, use may be made of the organyl compounds of the elements Be, Mg, Ca, Sr, Ba, B, Al, Ga, In, Tl, Zn, Cd, Hg.

The retarders used preferably comprise organyl aluminum compounds, organyl magnesium compounds, or organyl zinc compounds, or a mixture of these.

The organyl compounds present are the organometallic compounds of the elements mentioned having at least one metal-carbon σ bond, in particular the alkyl compounds or aryl compounds. Bonded to the metal, the organyl metal compounds may also contain hydrogen or halogen, or may contain organic radicals bonded via heteroatoms, examples being alcoholates or phenolates. The latter can be obtained by complete or partial hydrolysis, alcoholysis, or aminolysis, for example. It is also possible to use mixtures of various organyl metal compounds.

Organyl aluminum compounds which may be used are those of the formula R₃Al, the radicals R being, independently of one another, hydrogen, halogen, C₁-C₂₀-alkyl or C₆-C₂₀-aryl. Preferred organyl aluminum compounds are the trialkyl aluminum compounds, such as triethylaluminum, triisobutylaluminum, tri-n-butylaluminum, triisopropylaluminum, tri-n-hexylaluminum. It is particularly preferable to use triisobutylaluminum (TIBA). Other organyl aluminum compounds which may be used are those which are produced by partial or complete hydrolysis, alcoholysis, aminolysis, or oxidation of alkylaluminum or arylaluminum compounds. Examples are diethylaluminum ethoxide, diisobutylaluminum ethoxide, diisobutyl(2,6-di-tert-butyl-4-methylphenoxy)aluminum (CAS No. 56252-56-3), methylaluminoxane, isobutylated methylaluminoxane, isobutylaluminoxane, tetraisobutyldialuminoxane, or bis(diisobutyl)aluminum oxide.

Suitable organyl magnesium compounds are those of the formula R₂Mg, the radicals R being, independently of one another, hydrogen, halogen, C₁-C₂₀-alkyl, or C₆-C₂₀-aryl. Preference is given to the use of dialkylmagnesium compounds, in particular the ethyl, propyl, butyl, hexyl, or octyl compounds commercially available. It is particularly preferable to use (n-butyl)(sec-butyl)magnesium which is soluble in hydrocarbons.

Organyl zinc compounds which may be used are those of the formula R₂Zn, the radicals R being, independently of one another, hydrogen, halogen, C₁-C₂₀-alkyl, or C₆-C₂₀-aryl. Preferred organyl zinc compounds are dialkylzinc compounds, in particular having ethyl, propyl, butyl, hexyl, or octyl as alkyl radical. Diethylzinc is particularly preferred.

Of course, it is also possible to use two or more different organyl metal compounds, or two or more organyl aluminum, organyl magnesium, or organyl zinc compounds.

The amount of organyl alkali metal compound needed depends, inter alia, on the desired molecular weight (molar mass) of the polymer to be prepared, on the nature and amount of the organyl aluminum compounds, organyl magnesium compounds or organyl zinc compounds used, and on the polymerization temperature. Use is generally made of from 0.0001 to 10 mol %, preferably from 0.001 to 1 mol %, and particularly preferably from 0.01 to 0.2 mol %, of organyl alkali metal compound, based on the total amount of monomers used.

The amount needed of organyl aluminum compound, organyl magnesium compound, and, respectively, organyl zinc compound depends, inter alia, on the nature and amount of the organyl alkali metal compounds used, and on the polymerization temperature. It is usual to use from 0.0001 to 10 mol %, preferably from 0.001 to 1 mol %, and in particular from 0.01 to 0.2 mol %, of organyl aluminum compound, organyl magnesium compound, and, respectively, organyl zinc compound, based on the total amount of monomers used.

The molar ratio of organyl alkali metal compound (initiator) to organyl aluminum compound, organyl magnesium compound, and, respectively, organyl zinc compound (retarder) may vary within wide limits. It depends, for example, on the desired retardant action, on the polymerization temperature, on the nature and amount (concentration) of monomers used, and on the desired molecular weight of the polymer.

The anionic polymerization of the styrene is particularly preferably undertaken in the presence of the rubber (in particular of the styrene-butadiene block copolymer), in the presence of an initiator composition which is obtainable by mixing the organyl alkali metal compound (in particular the organyl lithium compound) with styrene, and then adding the organyl aluminum compound, organyl magnesium compound, or organyl zinc compound.

The anionic polymerization may in particular be undertaken in the presence of an initiator composition which is obtainable by mixing sec-butyllithium and styrene and then adding triisobutylaluminum (TIBA).

These processes are likewise provided by the invention.

It is likely that an oligomeric polystyrene-alkali metal compound forms from styrene and the organyl alkali metal compound, derived from polystyryl anion and alkali metal cation, and that the polymerization proceeds at the polystyryl anion. It is therefore likely that a compound [polystyryl]^{⊖}Li^{⊕} is formed from styrene and organyl lithium compound.

The amounts of organyl lithium compound and organyl aluminum compound are particularly preferably selected in such a way that the molar Al/Li ratio is in the range from 0.01:1 to 5:1, preferably from 0.5:1 to 1:1, in particular is about 0.95:1. The same principle applies to alkali metals other than Li.

The specified amounts or quantitative proportions of initiators and retarders are the amounts which are used during the polymerization of the styrene in the presence of the rubber, and do not take into account any initiators or retarders which may already be present in the rubber (e.g. if the rubber has also been prepared by anionic polymerization).

The initiator composition is preferably prepared with concomitant use of a solvent or suspending agent (depending on the solubility of the organyl alkali metal compound and, respectively, of the organyl compound of Al, Mg, and of Zn), these being given the abbreviated term solvent hereinafter. Particularly suitable solvents are inert hydrocarbons, more precisely aliphatic, cycloaliphatic or aromatic hydrocarbons, e.g. cyclohexane, methylcyclohexane, pentane, hexane, heptane, isooctane, benzene, toluene, xylene, ethylbenzene, decalin or paraffin oil, or a mixture of these. Toluene is particularly preferred.

In one preferred embodiment, the organyl aluminum compound, organyl magnesium compound, and, respectively, organyl zinc compound is used in solution in an inert hydrocarbon, e.g. toluene.

The mixing of the organyl alkali metal compound and styrene usually takes place with stirring at from 0 to 80° C., in particular from 20 to 50° C., particularly preferably from 20 to 30° C., and cooling may be required for this process. The organyl aluminum compound, organyl magnesium compound and, respectively, organyl zinc compound is added to the resultant mixture only after a certain waiting time, for example from 5 to 120 min, preferably from 10 to 30 min, after the mixing of styrene and organyl alkali metal compound.

The initiator composition may be allowed to age (stand) for a time after addition of the organyl Al compound, organyl Mg compound, and, respectively, organyl Zn compound.

The aging or standing of the freshly prepared initiator composition can be advantageous in some cases for reproducible use in the anionic polymerization. Experiments have shown that initiator components used separately from one another or mixed only briefly prior to initiation of the polymerization give rise in some cases to polymerization conditions and polymer properties which have less good reproducibility. The aging process observed is probably attributable to complex formation by the metal compounds, proceeding more slowly than the mixing procedure.

An aging time of about 2 minutes is generally sufficient for the concentration range and temperature range given above. The homogeneous mixture is preferably allowed to age for at least 5 minutes, in particular at least 20 minutes. However, it is generally also not disadvantageous if the homogeneous mixture is allowed to age for two or more hours, e.g. from 1 to 480 hours.

The initiator components may be mixed in any mixing assembly, preferably in one which can be provided with inert gas. Examples of suitable assemblies are stirred reactors with anchor stirrer, or a shaker vessel. For continuous preparation, particularly suitable assemblies are heatable tubes with static mixing elements. The mixing procedure is necessary for homogeneous mixing of the initiator components. During the aging process, however, mixing may continue or be discontinued. The aging may also take place in a stirred tank through which there is continuous flow, or in a tube section, the volume of which together with the through-flow rate determines the aging time.

The initiator composition described, obtainable by mixing the organyl alkali metal compound (in particular sec-butyllithium) and styrene and then adding the organyl Al compound, organyl Mg compound and, respectively, organyl Zn compound (in particular TIBA) is provided by the invention, as is the use described above of this initiator composition for preparing impact-modified polystyrene by anionic polymerization.

The polymerization of the styrene in the presence of the rubber may take place batchwise or continuously in stirred tanks, circulating reactors, tubular reactors, tower reactors, or rotating disk reactors, as described in WO 97/07766. The polymerization is preferably carried out continuously in a reactor arrangement composed of at least one back-mixing reactor (e.g. stirred tank) and of at least one non-back-mixing reactor (e.g. tower reactor).

After the polymerization of the styrene has ended, the reaction is preferably terminated using a protic substance, such as alcohols, e.g. isopropanol, phenols; water; or acids, e.g. aqueous carbon dioxide solution, or carboxylic acids, such as ethylhexanoic acid.

The content of styrene monomers in the impact-modified polystyrene of the invention is generally not more than 50 ppm, preferably not more than 10 ppm, and the content of styrene dimers and styrene trimers is generally not more than 500 ppm, preferably not more than 200 ppm, particularly preferably less than 100 ppm. The content of ethylbenzene in the impact-modified polystyrene is preferably below 5 ppm.

It can be advantageous to crosslink the rubber particles by using an appropriate temperature profile and/or by adding peroxides, in particular those with a high decomposition temperature, e.g. dicumyl peroxide. These peroxides are added after the polymerization has ended and, where appropriate, after addition of the chain terminator, and prior to devolatilization. However, it is preferable for thermal crosslinking of the soft phase to follow the polymerization at temperatures in the range from 200 to 300° C.

The impact-modified polystyrene of the invention may be used as it stands. However, it may also be blended with other thermoplastic polymers, e.g. with other polystyrenes, particularly with low-molecular-weight polystyrenes.

The invention therefore also provides thermoplastic molding compositions comprising
a) from 50 to 99.9% by weight, preferably from 80 to 99.9% by weight, and in particular from 90 to 99% by weight, of the anionically polymerized impact-modified polystyrene described above (A), and
b) from 0.1 to 50% by weight, preferably from 0.1 to 20% by weight, and in particular from 1 to 10% by weight, of a rubber-free or impact-modified (rubber-containing) polystyrene (B) polymerized by an anionic or free-radical route and having a number-average molar mass Mₙ of not more than 20 000 g/mol, determined by gel permeation chromatography (GPC) in tetrahydrofuran (THF).

The polystyrene B therefore has comparatively low molecular weight, i.e. is a low-molecular-weight polystyrene.

The polystyrene B is preferably prepared by anionic polymerization. In another preferred embodiment, the polystyrene B is rubber-free.

The number-average molar mass Mₙ of the polystyrene B is preferably not more than 16 000 g/mol, in particular from 6000 to 13 000 g/mol. The GPC measurement to determine Mₙ is usually calibrated with polystyrene calibration standards.

The preparation of the low-molecular-weight polystyrenes B is described by way of example in Ullmann's Encyclopedia of Industrial Chemistry, Sixth Edition, 2000 Electronic Release, Verlag Wiley VCH, keyword “Polystyrene and Styrene Copolymers”, and within this in particular chapter 1.2 “Polystyrene/Production”.

To improve tensile strain at break, from 0.1 to 10% by weight, preferably from 0.5 to 5% by weight, of mineral oil (white oil), based on the impact-modified polystyrene, may be added to the impact-modified polystyrene of the invention.

The polymers may comprise conventional additives and processing aids, e.g. lubricants, mold-release agents, colorants, e.g. pigments or dyes, flame retardants, antioxidants, light stabilizers, fibrous fillers or reinforcing agents, pulverulent fillers or reinforcing agents, or antistats, or else other additives, or a mixture of these.

Examples of suitable lubricants and mold-release agents are stearic acids, stearyl alcohol, stearic esters, stearamides, metal stearates, montan waxes, and waxes based on polyethylene and polypropylene.

Examples of pigments are titanium dioxide, phthalocyanines, ultramarine blue, iron oxides, or carbon black, and also the class of organic pigments. Dyes are any of the dyes which can be used for the transparent, semitransparent, or non-transparent coloring of polymers. Dyes of this type are known to the skilled worker.

Examples of flame retardants which may be used are the halogen-containing or phosphorus-containing compounds known to the skilled worker, magnesium hydroxide, and also other familiar compounds, or a mixture of these.

Examples of suitable antioxidants (heat stabilizers) are sterically hindered phenols, hydroquinones, various substituted representatives of this group, and also mixtures of these. Examples of these are commercially obtainable as Topanol® or Irganox®.

Examples of suitable light stabilizers are various substituted resorcinols, salicylates, benzotriazoles, benzophenones, HALS (hindered amine light stabilizers), e.g. those commercially available as Tinuvin®.

Examples which may be mentioned of fibrous or pulverulent fillers are carbon fibers or glass fibers in the form of glass fabrics, glass mats, or glass silk rovings, chopped glass, glass beads, and also wollastonite, glass fibers being particularly preferred.

When glass fibers are used, these may have been coated with a size and with a coupling agent to improve compatibility with the components of the blend. The glass fibers incorporated may either be short glass fibers or else continuous-filament strands (rovings).

Suitable particulate fillers are carbon black, amorphous silicate, magnesium carbonate, chalk, powdered quartz, mica, bentonites, talc, feldspar, or in particular calcium silicates, such as wollastonite, and kaolin.

Examples of suitable antistats are amine derivatives, such as N,N-bis(hydroxyalkyl)alkylamines or -alkyleneamines, polyethylene glycol ethers, or glycerol mono- and distearates, and also mixtures of these.

Each individual additive is used in the usual amount, and further details in this connection would therefore be superfluous.

The inventive impact-modified polystyrenes and thermoplastic molding compositions may be prepared by mixing processes known per se, for example with melting in an extruder, Banbury mixer, or kneader, or on a roll mill or calender. However, the components may also be mixed “cold”, the mixture composed of powder or pellets not being melted and homogenized until processing begins.

The impact-modified polystyrenes and thermoplastic molding compositions may be used to produce moldings of any type (including semifinished products, self-supporting and non-self-supporting films, and foams).

The invention therefore also provides the use of the inventive impact-modified polystyrenes and thermoplastic molding compositions to produce moldings, films, fibers, or foams, and the moldings, films, fibers, and foams obtainable from the impact-modified polystyrenes and thermoplastic molding compositions.

The polymers of the invention have low content of residual monomers and residual oligomers. This advantage is particularly valuable in the case of styrene-containing polymers, since the low content of residual styrene monomers and styrene oligomers means that there is no need for subsequent devolatilization—e.g. in a vented extruder, associated with higher costs and disadvantageous thermal degradation of the polymer (depolymerization).

The polymers of the invention also have good injection molding properties, in particular due to high flowabilities. In addition, the moldings obtainable therefrom have high gloss and good mechanical and thermal properties, in particular high Charpy notched impact strengths, high moduli of elasticity, yield stresses, tensile stresses at break, and penetration energies, and also good heat resistance measured by the Vicat method.

In particular, the gloss of the anionic polystyrene of the invention is better than the gloss of polystyrene prepared by a free-radical route—while its injection molding performance is just as good. In addition, the mechanical properties of the polystyrene of the invention are also superior to those of polystyrene prepared by a free-radical route, especially when the styrene-butadiene-styrene three-block copolymers mentioned are used as rubber component.

### EXAMPLES

The following compounds were used, “purified” meaning that aluminoxane was used for purification and drying:
styrene, purified, from BASF,
butadiene, purified, from BASF,
sec-butyllithium in the form of 12% strength by weight solution in cyclohexane, ready-to-use solution from Chemmetall,
triisobutylaluminum in the form of 20% strength by weight solution in toluene, ready-to-use solution from Crompton,
cyclohexane, purified, from BASF,
toluene, purified, from BASF.

1. Preparation of initiator composition

5210 g of toluene formed an initial charge at 25° C. in a 15 1 stirred tank, and 500 g of styrene and 518 g of the 12% strength by weight solution of sec-butyllithium in cyclohexane were added, with stirring. After 15 min, 913 g of the 20% strength by weight solution of triisobutylaluminum in toluene were added to the mixture, which was cooled to 40° C.

2. Preparation of rubber K1: butadiene-styrene two-block copolymer 120/95

473 1 of toluene, temperature-controlled to 45° C., formed an initial charge in a stirred tank of capacity 2 m³. 358 g of the 12% strength by weight solution of sec-butyllithium in cyclohexane were added. The following monomer portions M1 to M5 were then added in succession, the next portion not being added until the increased internal reactor temperature had fallen again to 45-55° C. as a result of evaporative cooling: M1, 24 kg of butadiene; M2, 20 kg of butadiene; M3, 16 kg of butadiene; M4, 13 kg of butadiene; M5, 57.4 kg of styrene. The above styrene portion M5 was added when the internal reactor temperature was higher by 10° C. than the temperature prior to the final butadiene addition M4. Finally, the reaction was terminated by adding 10.9 g of water. The solids content of the reaction mixture was 25% by weight, and the solids content of the reaction mixture was diluted to 16% by weight by adding 293 kg of styrene. The rubber solution therefore comprised 16% by weight of rubber, 49% by weight of toluene and 35% by weight of styrene.

GPC analysis (gel permeation chromatography in tetrahydrofuran, calibration using polystyrene standards and, respectively, polybutadiene standards) showed the block copolymer to have monomodal distribution. The residual butadiene content was smaller than 10 ppm.

The molecular weights (block lengths) were: butadiene block 120 000, styrene block 95 000, determined by GPC as described above. The butadiene content was 21.5% by weight.

3. Preparation of rubbers K2 and K3: styrene-butadiene-styrene three-block copolymer 11/155/85 and 10/110/80, variant data for K3 in brackets

473 1 of toluene, temperature-controlled to 45° C., formed an initial charge in a stirred tank of capacity 2 m³. 330 g (336 g) of the 12% strength by weight solution of sec-butyllithium in cyclohexane were added. The following monomer portions M1 to M6 were then added in succession, the next portion not being added until the increased internal reactor temperature had fallen again to 45-55° C. as a result of evaporative cooling: M1, 7.2 kg (8.5 kg) of styrene; M2, 25 kg (22 kg) of butadiene; M3, 21 kg (18 kg) of butadiene; M4, 16 kg (15 kg) of butadiene; M5, 15 kg (13 kg) of butadiene; M5, 45.7 kg (53.7 kg) of styrene. The above styrene portion M6 was added when the internal reactor temperature was higher by 10° C. than the temperature prior to the final butadiene addition M5. Finally, the reaction was terminated by adding 10.6 g of water. The solids content of the reaction mixture was 25% by weight, and the solids content of the reaction mixture was diluted to 16% by weight by adding 293 kg of styrene. The rubber solution therefore comprised 16% by weight of rubber, 49% by weight of toluene and 35% by weight of styrene.

GPC analysis (gel permeation chromatography in tetrahydrofuran, calibration using polystyrene standards and, respectively, polybutadiene standards) showed the block copolymer to have monomodal distribution. The residual butadiene content was smaller than 10 ppm.

The molecular weights (block lengths) for K2 were: first styrene block 11 000, butadiene block 155 000, second styrene block 85 000, and for K3 were: first styrene block 10 000, butadiene block 110 000, second styrene block 80 000, determined by GPC as described above. The butadiene content was 19.4% by weight for K2 and 21.8% by weight for K3.

4. Preparation of impact-modified polystyrene

In the general specification below, the variables A, B, C, etc. are the parameters which were varied. The individual values are given in table 1. Table 2 gives the composition of the additive solution.

The polymerization was carried out continuously in a jacketed 50 1 stirred tank with a standard anchor stirrer. The reactor was designed for an absolute pressure of 25 bar, and with a heating medium, and had temperature control for isothermal reaction conditions by way of evaporative cooling.

A kg/h of styrene, B kg/h of the rubber solution C, and D g/h of the initiator solution (initiator solution see item 1 above) are metered into the stirred tank continuously, with stirring at 115 rpm, and held at a constant internal reactor temperature E. The conversion at the outlet of the stirred tank was 40%. The reaction mixture was conveyed into a stirred 29 1 tower reactor provided with two heating zones of equal size (first zone 110° C., second zone 160° C. internal temperature). The discharge from the tower reactor was treated with F g/h of an additive solution G, and then conducted through a mixer, and finally through a tube section heated to 250° C. The mixture was then conducted by way of a pressure regulator valve into a partial evaporator operated at 300° C., and depressurized into a vacuum vessel operated at an absolute pressure of 10 mbar. A conveying screw was used to discharge and pelletize the polymer melt. The conversion was quantitative.

TABLE 1
Individual values of the variables for preparing impact-modified polystyrene

| | A | B | | D | E | F | |
|---|---|---|---|---|---|---|---|
| | Styrene | Rubber | C | Initiator | Internal | Additive | G |
| Variable | feed | solution feed | Rubber | solution feed | reactor temp. | solution feed | Additive |
| → | [kg/h] | [kg/h] | solution | [g/h] | [° C.] | [g/h] | solution |
| Ex. 1 | 2.7 | 13.4 | K1 | 500 | 112 | 787 | G1 |
| Ex. 2 | 2.9 | 13.2 | K2 | 500 | 115 | 817 | G1 |
| Ex. 3 | 2.9 | 13.2 | K2 | 400 | 117 | 802 | G2 |
| Ex. 4c | 2.1 | 13.95 | K3 | 380 | 116 | 752 | G3 |
| Ex. 5 | 2.1 | 13.95 | K3 | 500 | 116 | 767 | G4 |

TABLE 2
Composition of additive solution G [% by weight]

| | G1 | G2 | G3 | G4 |
|---|---|---|---|---|
| Antioxidant ¹⁾ | 2 | 2.1 | 2.1 | 2.1 |
| Toluene | 15 | 15 | 15 | 15 |
| 2-Ethylhexanoic acid | 9 | 7.5 | 7.9 | 9.8 |
| White oil ²⁾ | 74 | 75.4 | 75 | 73.4 |

¹⁾ Octadecyl 3-(3,5-di-tert-butyl-4-hydroxyphenyl)propionate was used, commercially available as Irganox ® 1076 from Ciba-Geigy.
²⁾ The mineral oil Winok ® 70 from Wintershall was used.

For comparison (example 6c), an impact-modified polystyrene obtained by free-radical polymerization was used. The polystyrene was prepared as in WO 00/32662, example 1 on page 8, lines 1 to 25.

5. Properties of impact-modified polystyrene

The resultant impact-modified polystyrene was pelletized and dried. The pellets were injection molded at a melt temperature of 230° C. and a mold surface temperature of 45° C. (unless otherwise stated below) to give the appropriate test specimens.

The following properties were determined:

Heat resistance by the Vicat B method: determined as Vicat softening point VSP, method B50 (force 50 N, heating rate 50° C./h) to EN ISO 306, on test specimens produced to EN ISO 3167.

Melt volume flow ratio MVR: determined on pellets to EN ISO 1133 at a test temperature of 200° C. with a nominal load of 5 kg.

Gel content: determined on pellets as follows: about 5 g of pellets were post-crosslinked for 90 min under nitrogen at 280° C. in a heating cabinet. About 2.6 g of the post-crosslinked pellets were treated at 25° C. with an amount of toluene such that the polymer content of the mixture was 5.74% by weight. 18 g of the mixture were placed in a weighed centrifuge beaker, and the specimen was centrifuged for 60 min at 16 000 rpm. The supernatant solution was decanted (time allowed 3 sec), and the remaining specimen was dried in the centrifuge beaker for 120 min at 140° C. The cooled beaker was weighed. The weight of polymer used was calculated.

$$Gel content = \frac{Weight of dried specimen}{Weight of specimen used prior to swelling} \cdot 100 \%$$

Swelling index: determined on pellets as follows: about 2.6 g of the (uncrosslinked) pellets were swollen in toluene, centrifuged, decanted, and dried, as described for the measurement of gel content.

$$Swelling index = \frac{Weight of swollen specimen after decanting}{Weight of dried specimen}$$

Viscosity number VN: corrected VN determined to DIN 53726 on a 0.5% strength by weight solution of the impact-modified polystyrene in toluene at 23° C.

Iodine number: as measure of polybutadiene content, determined to DIN 53241-1 (May 1995) inc. Appendix A.

Particle sizes d₁₀, d₅₀, d₉₀ of the rubber particles, determined using the Malvern Instruments Mastersizer. The d₁₀ is the particle diameter relative to which the diameter of 10% by weight of all of the particles is smaller and that of 90% by weight of all of the particles is larger. Conversely, 90% by weight of all of the particles have a diameter smaller than the diameter corresponding to the d₉₀, and 10% by weight of all of the particles have a diameter larger than the diameter corresponding to the d₉₀. The ponderal median particle diameter d₅₀ is the particle diameter relative to which the diameter of 50% by weight of all of the particles is larger and that of 50% by weight of all of the particles is smaller. The d₁₀, d₅₀, and d₉₀ values characterize the breadth of the particle size distribution.

Charpy impact strength aₙ: determined to EN ISO 179/leU (=test specimen type 1, impact direction e edge, non-notched) on test specimens produced to EN ISO 3167, at 23 and −30° C.

Charpy impact strength aₖ: determined to EN ISO 179/leA (=test specimen type 1, impact direction e edge, notch type A, V-shaped) with milled notch, at 23 and −30° C.

Modulus of elasticity E, yield stress σₛ, tensile stress at break σ_{R}, yield elongation ε_{S} and nominal tensile strain at break ε_{R}: each determined in the tensile test to EN ISO 527 (DIN EN ISO 527-1 and 527-2) at 23° C.

Penetration energy W_{ges}: determined in the penetration test to EN ISO 6603-2 at 23° C., the test specimen having been produced at 200, 230 or 260° C. (melt temperature).

Gloss: 20° reflectometer value determined to DIN 67530 on a test specimen produced at 240, 260 or 280° C. (melt temperature), using a LMG 070 laboratory reflectometer from Dr. Bruno Lange at 23° C.

Molecular weight M_{w} (weight-average) and Mₙ (number-average): determined using gel permeation chromatography GPC in tetrahydrofuran, calibrated with polystyrene calibration standards.

Residual content: of styrene monomer or of ethylbenzene, determined using gas chromatography.

Table 3 gives the results from the impact-modified polystyrene

TABLE 3
Properties of impact-modified polystyrene

| | Example | | | | | |
|---|---|---|---|---|---|---|
| | 1 | 2 | 3 | 4c | 5 | 6c |
| Heat resistance by | 91.9 | 90.6 | 90.5 | 91.4 | 87.9 | 89.8 |
| the Vicat B method | | | | | | |
| [° C.] | | | | | | |
| Flow ratio MVR | 12.2 | 11.4 | 8.4 | 6.5 | 12.3 | 11.6 |
| 200° C./5 kg | | | | | | |
| [cm³/10 min] | | | | | | |
| Gel content [%] | 25.8 | 27.9 | 26.5 | 25.7 | 24.0 | 25.9 |
| Swelling index | 3.0 | 10.6 | 10.0 | 2.9 | 3.2 | 12.2 |
| Viscosity number VN | 57.5 | 57.9 | 62.5 | 65.0 | 58.4 | 64.9 |
| [ml/g] | | | | | | |
| Iodine number | 53.4 | 53.2 | 54.0 | 52.3 | 52.3 | 36.9 |
| Particle size [μm] | | | | | | |
| d₁₀ | 0.28 | 0.37 | 0.51 | 0.37 | 0.37 | 0.83 |
| d₅₀ | 0.45 | 0.78 | 0.91 | 0.66 | 0.69 | 1.67 |
| d₉₀ | 0.74 | 1.73 | 1.78 | 1.15 | 1.42 | 3.10 |
| Charpy impact | | | | | | |
| strength aₙ [kJ/m²] | | | | | | |
| 23° C. | 39 | nd | nd | 123 | nd | 200 |
| −30° C. | 18 | 156 | 191 | 117 | nd | 93 |
| Charpy notched | | | | | | |
| impact strength a_{K} | | | | | | |
| [kJ/m²] | | | | | | |
| 23° C. | 8.2 | 19.1 | 16.3 | 24.4 | 21.7 | 16.2 |
| −30° C. | 2.3 | 2.4 | 2.7 | 2.5 | 2.4 | 3.0 |
| Modulus of | 1968 | 1910 | 1894 | 1950 | 1901 | 2090 |
| elasticity E [MPa] | | | | | | |
| Yield stress σ_{S} | 30.5 | 29.1 | 28.3 | 30.8 | 26.9 | 26.9 |
| [MPa] | | | | | | |
| Tensile stress at | 21.9 | 21.4 | 21.4 | 22.6 | 19.5 | 22.2 |
| break σ_{R} [MPa] | | | | | | |
| Yield elongation ε_{S} | 1.8 | 1.8 | 1.7 | 1.8 | 1.6 | 1.4 |
| [%] | | | | | | |
| Tensile strain at | 16 | 31 | 42 | 20 | 22 | 34 |
| break ε_{R} [%] | | | | | | |
| Penetration energy | | | | | | |
| W_{ges} [Nm], melt temp. | | | | | | |
| 200° C. | 5.7 | 14.5 | 14.9 | 14.8 | 14.4 | 12.6 |
| 230° C. | 6.3 | 17.7 | 20.2 | 17.3 | 18.2 | 11.5 |
| 260° C. | 13.1 | 16.9 | 21.0 | 26.4 | 19.3 | 15.6 |
| Gloss [%], Melt temp. | | | | | | |
| 240° C. | nd | 42.8 | 26.1 | 55.4 | 63.8 | 19 |
| 260° C. | 68 | 45.9 | 32.3 | 61.3 | 66.1 | 23 |
| 280° C. | 70 | 50.6 | 38.1 | 61.9 | 68.3 | 27 |
| Mol. mass [g/mol] | | | | | | |
| Mₙ | 64000 | 70000 | 76100 | 73500 | 65200 | nd |
| M_{w} | 124000 | 130400 | 151500 | 153200 | 125600 | nd |
| Residual content | | | | | | |
| [ppm] | | | | | | |
| styrene monomer | <5 | <5 | <5 | <5 | <5 | 400 |
| ethylbenzene | <5 | <5 | <5 | <5 | <5 | 30 |

(nd = not determined)

The examples show the balanced property profile of the anionically polymerized impact-modified polystyrene of the invention. Content of residual monomers was low. Injection molding properties were particularly excellent, due to the high MVR.

The moldings produced from the polystyrene of the invention had good mechanical properties, in particular good Charpy notched impact strengths, high moduli of elasticity, yield stresses, tensile stresses at break, and penetration energies, and also high gloss and good heat resistances.

Tailored property profiles could be obtained by using additives (here G1- G4, table 2).

Example 4c is a comparative example, since the very low MVR of 6.5 cm³/10 min is non-inventive.

Example 6c is a comparative example because the impact-modified polystyrene concerned has been prepared by a free-radical route—not according to the invention. Comparison of the properties of the “free-radical” example 6c with the properties of the “anionic” example shows that the mechanical, optical, thermal and injection molding properties of the anionic polystyrene of the invention are certainly at the same high level as those of the conventional free-radical polystyrene—while the anionic polystyrene has advantageous and substantially lower residual monomer content.

In particular, when anionic polystyrenes of the invention were prepared using styrene-butadiene-styrene three-block copolymer (Ex. 2, 3, 5 comprising three-block S-B-S copolymer K2 and, respectively, K3), mechanical properties are better than for the comparative free-radical polystyrene (Ex. 6c): yield stress as, yield elongation εₛ, and penetration energies W_{ges} have been improved in the anionic polystyrene and compared with the free-radical polystyrene—while flowability MVR is equally good.

Irrespective of whether the rubber used comprises a two-block or three-block copolymer, gloss was higher for the anionic polystyrene of the invention than for the free-radical polystyrene.

6. Preparation of thermoplastic molding compositions

The anionic impact-modified polystyrenes from the above examples 1 to 5 were blended with an anionically polymerized rubber-free low-molecular-weight standard polystyrene to prepare thermoplastic molding compositions.

The components used were the following:

| | |
|---|---|
| anion. PS from Ex. | . . . anionic impact-modified polystyrene from |
| | examples 1, 2, 3, 4c, or 5 |
| low-molecular- | anionic rubber-free polystyrene with |
| weight PS 1: | number-average molar mass Mₙ of |
| | 12 000 g/mol, determined by means of |
| | GPC as described above. |
| low-molecular- | as PS 1, but Mₙ 7000 g/mol. |
| weight PS 2: | |

The constituent amounts given in table 4 of the components were intimately mixed and melted in a Werner+Pfleiderer ZSK30/5 twin-screw extruder at 200° C. and output 10 kg/h, and the melt was discharged and pelletized.

Tables 4a to 4e give the compositions and results.

Examples 7, 12, 17, 22c, and 27 are identical with the above examples 1, 2, 3, 4c, and 5 (100% by weight of impact-modified polystyrene), and are listed again to improve the comparability of the data.

TABLE 4a
Properties of thermoplastic molding compositions

| EX. | | | | |
|---|---|---|---|---|
| 7 | 8 | 9 | 10 | 11 |

Composition

| | | | | | |
|---|---|---|---|---|---|
| Anion. PS from | 100 | 97 | 95 | 97 | 95 |
| Ex. 1 | | | | | |
| low-molecular- | — | 3 | 5 | — | — |
| weight PS 1 | | | | | |
| low-molecular- | — | — | — | 3 | 5 |
| weight PS 2 | | | | | |

Properties

| | | | | | |
|---|---|---|---|---|---|
| Heat resistance | 91.9 | 91.5 | 91.8 | 91.6 | 91.7 |
| by the Vicat B | | | | | |
| method [° C.] | | | | | |
| Flow ratio MVR | 12.2 | 13.8 | 14.9 | 14.0 | 15.2 |
| 200° C./5 kg | | | | | |
| [cm³/10 min] | | | | | |
| Gel content [%] | 25.8 | 24.9 | 24.0 | 25.5 | 25.8 |
| Swelling index | 3.0 | 3.0 | 3.2 | 2.7 | 2.7 |
| Viscosity number | 57.5 | 55.6 | 53.9 | 55.1 | 54.5 |
| VN [ml/g] | | | | | |
| Iodine number | 53.4 | 51.5 | 50.8 | 50.9 | 49.7 |
| Particle size | | | | | |
| [μm] | | | | | |
| d₁₀ | 0.28 | 0.31 | 0.31 | 0.31 | 0.32 |
| d₅₀ | 0.45 | 0.48 | 0.48 | 0.48 | 0.48 |
| d₉₀ | 0.74 | 0.76 | 0.76 | 0.76 | 0.76 |
| Charpy impact | | | | | |
| strength | | | | | |
| aₙ [kJ/m²] | | | | | |
| 23° C. | 39 | 38 | 36 | 38 | 37 |
| −30° C. | 18 | 16 | 16 | 17 | 17 |
| Charpy notched | | | | | |
| impact strength | | | | | |
| aₖ [kJ/m²] | | | | | |
| 23° C. | 8.2 | 7.7 | 7.4 | 7.5 | 7.4 |
| −30° C. | 2.3 | 2.4 | 2.2 | 2.3 | 1.7 |
| Modulus of | 1968 | 1990 | 2011 | 2005 | 2026 |
| elasticity E | | | | | |
| [MPa] | | | | | |
| Yield stress σ_{S} | 30.5 | 30.4 | 30.2 | 30.5 | 30.7 |
| [MPa] | | | | | |
| Tensile stress | 21.9 | 22.1 | 22.1 | 22.0 | 22.1 |
| at break σ_{R} | | | | | |
| [MPa] | | | | | |
| Yield elongation | 1.8 | 1.8 | 1.7 | 1.8 | 1.8 |
| ε_{S} [%] | | | | | |
| Tensile strain | 16 | 12 | 11 | 15 | 16 |
| at break ε_{R} [%] | | | | | |
| Penetration | | | | | |
| energy W_{ges} | | | | | |
| [Nm], melt temp. | | | | | |
| 200° C. | 5.7 | 3.9 | 3.4 | 3.4 | 2.8 |
| 230° C. | 6.3 | 3.8 | 4.2 | 4.7 | 3.8 |
| 260° C. | 13.1 | 6.3 | 4.6 | 8.2 | 9.8 |

(nd = not determined, and composition [% by weight])

TABLE 4b
Properties of thermoplastic molding compositions

| Ex. | | | | |
|---|---|---|---|---|
| 12 | 13 | 14 | 15 | 16 |

Composition

| | | | | | |
|---|---|---|---|---|---|
| Anion. PS from | 100 | 97 | 95 | 97 | 95 |
| Ex. 2 | | | | | |
| low-molecular- | — | 3 | 5 | — | — |
| weight PS 1 | | | | | |
| low-molecular- | — | — | — | 3 | 5 |
| weight PS 2 | | | | | |

Properties

| | | | | | |
|---|---|---|---|---|---|
| Heat resistance | 90.6 | 91.2 | 91.2 | 91.3 | 91.1 |
| by the Vicat B | | | | | |
| method [° C.] | | | | | |
| Flow ratio MVR | 11.4 | 13.0 | 14.8 | 12.9 | 14.2 |
| 200° C./5 kg | | | | | |
| [cm³/10 min] | | | | | |
| Gel content [%] | 27.9 | 27.1 | 26.6 | 26.6 | 26.8 |
| Swelling index | 10.6 | 9.9 | 9.9 | 9.8 | 9.9 |
| Viscosity number | 57.9 | 55.9 | 54.1 | 55.7 | 55.2 |
| VN [ml/g] | | | | | |
| Iodine number | 53.2 | 52.6 | 50.9 | 51.9 | 51.4 |
| Particle size | | | | | |
| [μm] | | | | | |
| d₁₀ | 0.37 | 0.37 | 0.37 | 0.37 | 0.38 |
| d₅₀ | 0.78 | 0.78 | 0.78 | 0.78 | 0.81 |
| d₉₀ | 1.73 | 1.73 | 1.72 | 1.71 | 1.72 |
| Charpy impact | | | | | |
| strength | | | | | |
| aₙ [kJ/m²] | | | | | |
| 23° C. | nd | 149 | 148 | nd | 170 |
| −30° C. | 156 | 93 | 107 | 137 | 131 |
| Charpy notched | | | | | |
| impact strength | | | | | |
| aₖ [kJ/m²] | | | | | |
| 23° C. | 19.1 | 17.3 | 15.4 | 17.3 | 22.0 |
| −30° C. | 2.4 | 2.4 | 2.5 | 2.4 | 2.3 |
| Modulus of | 1910 | 1920 | 1936 | 1939 | 1958 |
| elasticity E [MPa] | | | | | |
| Yield stress | 29.1 | 29.1 | 29.0 | 29.4 | 29.5 |
| σ_{S} [MPa] | | | | | |
| Tensile stress | 21.4 | 20.9 | 20.9 | 21.4 | 21.4 |
| at break σ_{R} | | | | | |
| [MPa] | | | | | |
| Yield elongation | 1.8 | 1.7 | 1.7 | 1.8 | 1.7 |
| ε_{S}[%] | | | | | |
| Tensile strain | 31 | 21 | 20 | 27 | 27 |
| at break ε_{R} [%] | | | | | |
| Penetration | | | | | |
| energy W_{ges} | | | | | |
| [Nm], melt temp. | | | | | |
| 200° C. | 14.5 | 12.4 | 12.8 | 14.0 | 12.6 |
| 230° C. | 17.7 | 15.4 | 14.0 | 15.5 | 13.3 |
| 260° C. | 16.9 | 12.8 | 12.4 | 15.6 | 13.2 |

(nd = not determined, composition [% by weight])

TABLE 4c
Properties of thermoplastic molding compositions

| Ex. | | | | |
|---|---|---|---|---|
| 17 | 18 | 19 | 20 | 21 |

Composition

| | | | | | |
|---|---|---|---|---|---|
| Anion. PS from | 100 | 97 | 95 | 97 | 95 |
| Ex. 3 | | | | | |
| low-molecular- | — | 3 | 5 | — | — |
| weight PS 1 | | | | | |
| low-molecular- | — | — | — | 3 | 5 |
| weight PS 2 | | | | | |

Properties

| | | | | | |
|---|---|---|---|---|---|
| Heat resistance | 90.5 | 89.5 | 90.1 | 90.3 | 90.1 |
| by the Vicat B | | | | | |
| method [° C.] | | | | | |
| Flow ratio MVR | 8.4 | 9.7 | 11.1 | 9.8 | 10.8 |
| 200° C./5 kg | | | | | |
| [cm³/10 min] | | | | | |
| Gel content [%] | 26.5 | 27.7 | 27.1 | 26.8 | 26.8 |
| Swelling index | 10.0 | 10.0 | 10.1 | 10.4 | 9.9 |
| Viscosity number | 62.5 | 60.2 | 58.9 | 59.1 | 60.4 |
| VN [ml/g] | | | | | |
| Iodine number | 54.0 | 52.4 | 51.8 | 51.3 | 52.0 |
| Particle size | | | | | |
| [μm] | | | | | |
| d₁₀ | 0.51 | 0.50 | 0.49 | 0.51 | 0.52 |
| d₅₀ | 0.91 | 0.89 | 0.90 | 0.90 | 0.90 |
| d₉₀ | 1.78 | 1.76 | 1.83 | 1.78 | 1.81 |
| Charpy impact | | | | | |
| strength | | | | | |
| aₙ [kJ/m²] | | | | | |
| 23° C. | nd | nd | 167 | 205 | nd |
| −30° C. | 191 | 148 | 114 | 171 | 142 |
| Charpy notched | | | | | |
| impact strength | | | | | |
| aₖ [kJ/m²] | | | | | |
| 23° C. | 16.3 | 22.7 | 17.9 | 20.0 | 18.5 |
| −30° C. | 2.7 | 2.5 | 2.4 | 2.7 | 2.4 |
| Modulus of | 1894 | 1944 | 1917 | 1907 | 1938 |
| elasticity E [MPa] | | | | | |
| Yield stress σ_{S} | 28.3 | 29.1 | 28.3 | 28.5 | 28.6 |
| [MPa] | | | | | |
| Tensile stress | 21.4 | 22.3 | 20.8 | 21.3 | 21.2 |
| at break σ_{R} | | | | | |
| [MPa] | | | | | |
| Yield elongation ε_{S} | 1.7 | 1.8 | 1.7 | 1.7 | 1.7 |
| [%] | | | | | |
| Tensile strain | 42 | 31 | 28 | 37 | 33 |
| at break ε_{R} [%] | | | | | |
| Penetration | | | | | |
| energy W_{ges} | | | | | |
| [Nm], melt temp. | | | | | |
| 200° C. | 14.9 | 14.4 | 13.7 | 15.1 | 13.0 |
| 230° C. | 20.2 | 15.7 | 15.9 | 17.9 | 16.2 |
| 260° C. | 21.0 | 15.5 | 14.0 | 17.8 | 15.8 |

(nd = not determined, composition [% by weight])

TABLE 4d
Properties of thermoplastic molding compositions

| Ex. | | | | |
|---|---|---|---|---|
| 22c | 23c | 24c | 25c | 26c |

Composition

| | | | | | |
|---|---|---|---|---|---|
| Anion. PS from | 100 | 97 | 95 | 97 | 95 |
| Ex. 4c | | | | | |
| low-molecular- | — | 3 | 5 | — | — |
| weight PS 1 | | | | | |
| low-molecular- | — | — | — | 3 | 5 |
| weight PS 2 | | | | | |

Properties

| | | | | | |
|---|---|---|---|---|---|
| Heat resistance | 91.4 | 92.1 | 91.1 | 91.4 | 91.4 |
| by the Vicat B | | | | | |
| method [° C.] | | | | | |
| Flow ratio MVR | 6.5 | 7.7 | 8.0 | 7.8 | 8.3 |
| 200° C./5 kg | | | | | |
| [cm³/10 min] | | | | | |
| Gel content [%] | 25.7 | 25.0 | nd | 24.2 | 23.3 |
| Swelling index | 2.9 | 3.0 | nd | 3.0 | 2.8 |
| Viscosity number | 65.0 | 63.3 | 62.9 | 63.4 | 61.8 |
| VN [ml/g] | | | | | |
| Iodine number | 52.3 | 50.9 | 50.7 | 50.8 | 50.1 |
| Particle size | | | | | |
| [μm] | | | | | |
| d₁₀ | 0.37 | 0.37 | 0.37 | 0.37 | 0.37 |
| d₅₀ | 0.66 | 0.66 | 0.66 | 0.66 | 0.66 |
| d₉₀ | 1.15 | 1.15 | 1.15 | 1.14 | 1.15 |
| Charpy impact | | | | | |
| strength | | | | | |
| aₙ [kJ/m²] | | | | | |
| 23° C. | 123 | 172 | 138 | nd | nd |
| −30° C. | 117 | 134 | 113 | 213 | 173 |
| Charpy notched | | | | | |
| impact strength | | | | | |
| aₖ [kJ/m²] | | | | | |
| 23° C. | 24.4 | 23.0 | 21.4 | 23.2 | 21.6 |
| −30° C. | 2.5 | 2.5 | 2.9 | 2.7 | 2.4 |
| Modulus of | 1950 | 1972 | 1984 | 1967 | 1994 |
| elasticity E [MPa] | | | | | |
| Yield stress | 30.8 | 30.8 | 30.8 | 30.9 | 31.1 |
| σ_{S} [MPa] | | | | | |
| Tensile stress | 22.6 | 22.8 | 22.5 | 22.8 | 22.9 |
| at break σ_{R} | | | | | |
| [MPa] | | | | | |
| Yield elongation | 1.8 | 1.8 | 1.8 | 1.8 | 1.8 |
| ε_{S} [%] | | | | | |
| Tensile strain | 20 | 26 | 20 | 23 | 24 |
| at break ε_{R} [%] | | | | | |
| Penetration | | | | | |
| energy W_{ges} | | | | | |
| [Nm], melt temp. | | | | | |
| 200° C. | 14.8 | 12.3 | 11.0 | 13.0 | 12.0 |
| 230° C. | 17.3 | 15.8 | 15.7 | 17.1 | 16.4 |
| 260° C. | 26.4 | 18.6 | 16.2 | 22.8 | 18.5 |

(nd = not determined, composition [% by weight])

TABELLE 4e
Properties of thermoplastic molding compositions

| Ex. | | | | |
|---|---|---|---|---|
| 27 | 28 | 29 | 30 | 31 |

Composition

| | | | | | |
|---|---|---|---|---|---|
| Anion. PS from | 100 | 97 | 95 | 97 | 95 |
| Ex. 5 | | | | | |
| low-molecular- | — | 3 | 5 | — | — |
| weight PS 1 | | | | | |
| low-molecular- | — | — | — | 3 | 5 |
| weight PS 2 | | | | | |

Properties

| | | | | | |
|---|---|---|---|---|---|
| Heat resistance | 87.9 | 88.2 | 87.5 | 88.9 | 88.2 |
| by the Vicat B | | | | | |
| method [° C.] | | | | | |
| Flow ratio MVR | 12.3 | 14.9 | 16.9 | 14.5 | 16.4 |
| 200° C./5 kg | | | | | |
| [cm³/10 min] | | | | | |
| Gel content [%] | 24.0 | 23.8 | 23.3 | 24.0 | 22.9 |
| Swelling index | 3.2 | 3.2 | 3.2 | 3.0 | 3.0 |
| Viscosity number | 58.4 | 56.5 | 55.6 | 57.3 | 56.0 |
| VN [ml/g] | | | | | |
| Iodine number | 52.3 | 50.9 | 50.1 | 51.6 | 50.6 |
| Particle size | | | | | |
| [μm] | | | | | |
| d₁₀ | 0.37 | 0.35 | 0.37 | 0.36 | 0.37 |
| d₅₀ | 0.69 | 0.70 | 0.70 | 0.70 | 0.70 |
| d₉₀ | 1.42 | 1.55 | 1.43 | 1.52 | 1.42 |
| Charpy impact | | | | | |
| strength | | | | | |
| aₙ [kJ/m²] | | | | | |
| 23° C. | nd | 182 | 113 | nd | 175 |
| −30° C. | 153 | 105 | 93 | 182 | 174 |
| Charpy notched | | | | | |
| impact strength | | | | | |
| aₖ [kJ/m²] | | | | | |
| 23° C. | 21.7 | 19.6 | 18.1 | 19.6 | 18.1 |
| −30° C. | 2.4 | 2.4 | 2.4 | 2.7 | 2.4 |
| Modulus of | 1901 | 1904 | 1908 | 1923 | 1943 |
| elasticity E [MPa] | | | | | |
| Yield stress σ_{S} | 26.9 | 26.8 | 26.7 | 27.1 | 27.1 |
| [MPa] | | | | | |
| Tensile stress | 19.5 | 19.4 | 19.2 | 19.6 | 19.5 |
| at break σ_{R} | | | | | |
| [MPa] | | | | | |
| Yield elongation | 1.6 | 1.6 | 1.6 | 1.6 | 1.6 |
| ε_{S} [%] | | | | | |
| Tensile strain | 22 | 22 | 14 | 25 | 21 |
| at break ε_{R} [%] | | | | | |
| Penetration | | | | | |
| energy W_{ges} | | | | | |
| [Nm], melt temp. | | | | | |
| 200° C. | 14.4 | 14.0 | 11.0 | 14.1 | 13.4 |
| 230° C. | 18.2 | 15.6 | 11.9 | 15.6 | 13.3 |
| 260° C. | 19.3 | 13.8 | 13.2 | 15.0 | 11.6 |

(nd = not determined, composition [% by weight])

The examples show that the properties of the impact-modified anionic polystyrene can be tailored by adding small amounts (as little as 3 or 5% by weight, based on the thermoplastic molding composition) of a low-molecular-weight, rubber-free standard polystyrene.

The change in properties is particularly marked in the case of the flow rate MVR (e.g. Ex. 27 without free-radical PS 12.3, Ex. 29 with 5% by weight of free-radical PS 16.9 cm³/10 min), in the case of impact strength aₙ (e.g. Ex. 27 109, Ex. 28 182 kJ/m² at 23° C.), notched impact strength a_{K} (e.g. Ex. 17 16.3, Ex. 18 22.7 kJ/m² at 23° C.), and in the case of penetration energy W_{ges} (e.g. Ex. 7 13.1, Ex. 9 4.6 Nm at 260° C. melt temperature).

Addition of the rubber-free low-molecular-weight standard polystyrene altered some values “upward” and other values “downward” when comparison is made with impact-modified anionic polystyrene without addition of low-molecular-weight polystyrene. Addition of only small amounts of the low-molecular-weight standard polystyrene to the anionic polystyrene of the invention therefore permits preparation of thermoplastic molding compositions whose properties have been optimized for certain applications.

In particular, as shown by the examples, addition of small amounts of a low-molecular-weight standard polystyrene can markedly improve the injection molding properties of the anionic polystyrene of the invention, i.e. the MVR, while retaining the good mechanical and other properties of the anionic polystyrene.

1. A process for preparing impact-modified polystyrene comprising anionic polymerization of styrene in the presence of a styrene-butadiene block copolymer, wherein: the process comprises using an organyl alkali metal compound as an anionic polymerization initiator, and an organyl aluminum compound as a retarder; and the impact-modified polystyrene has a melt volume flow ratio MVR of at least 8 cm³/10 min, measured to EN ISO 1133 at a test temperature of 200° C. with a nominal load of 5 kg.

2. The process according to claim 1, where sec-butyllithium is used as an anionic polymerization initiator.

3. The process according to claim 1, where triisobutylaluminum (TIBA) is used as a retarder.

4. The process according to claim 1, where the anionic polymerization is undertaken in the presence of an initiator composition which is obtainable by mixing sec-butyllithium and styrene, and then adding TIBA.

5. A process for preparing thermoplastic molding compositions, said molding compositions comprising:
a) from 50 to 99.9% by weight of an anionically polymerized impact-modified polystyrene that is prepared according to claim 1; and
b) from 0.1 to 50% by weight of a rubber-free or impact-modified polystyrene polymerized by an anionic or free-radical route and having a number-average molar mass of not more than 20,000 g/mol, determined by gel permeation chromatography in tetrahydrofuran.

6. The process according to claim 2, where triisobutylaluminum (TIBA) is used as a retarder.

7. The process according to claim 2, where the anionic polymerization is undertaken in the presence of an initiator composition which is obtainable by mixing sec-butyllithium and styrene, and then adding TIBA.

8. The process according to claim 3, where the anionic polymerization is undertaken in the presence of an initiator composition which is obtainable by mixing sec-butyllithium and styrene, and then adding TIBA.
